(19) United States
(12) Patent Application Publication
(10) Pub. No.: US 2006/0080713 A1
(43) Pub. Date: Apr. 13, 2006

(54) Television set

(75) Inventors: Toshihiro Fujibayashi, Hino-shi (JP); Noriyuki Hirayama, Fuchu-shi (JP); Tomohiro Kanda, Saitama-shi (JP); Masafumi Tamura, Chofu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/221,842

(22) Filed: Sep. 9, 2005

(30) Foreign Application Priority Data
Sep. 30, 2004 (JP) 2004-286761

(51) Int. Cl. H04N 5/445

(52) U.S. Cl. 725/78; 725/51

(57) ABSTRACT

A control unit responds to an operating command from a remote controller received by a light receiving unit to switch the subject of display on an image display unit to image information applied to an input terminal and sends the image information over a network via a communication I/F to a location with which connection has been set up. Upon receiving a command to select a dedicated channel which is, for example, an idle channel from the remote controller, the control unit receives image information transmitted from a location connected by the network through the communication I/F and transfers it to a signal processing unit. The received image information is then displayed on an image display unit.

### CROSS-REFERENCE TO RELATED APPLICATIONS

This application is based upon and claims the benefit of priority from prior Japanese Patent Application No. 2004-286761, filed Sep. 30, 2004, the entire contents of which are incorporated herein by reference.

### BACKGROUND OF THE INVENTION

1. Field of the Invention

The present invention relates to a television set which has a communication function of transmitting and receiving image information via a network, such as the Internet or the like.

2. Description of the Related Art

In recent years, digitization of television broadcasting has advanced. That is, terrestrial digital broadcasting has also been started in addition to satellite digital broadcasting such as BS (broadcasting satellite) digital broadcasting and 110 CS (communication satellite) digital broadcasting.

Many television sets capable of receiving digital broadcasts have a function of transmitting information over the Internet to implement interactive communication of returning some response over the Internet in so-called viewer-participation programs.

With improvements in moving-image compression coding technology and communication image processing technology, in addition to advances in information communication related infrastructure, a television communication system has also been proposed which allows image and audio information to be communicated between personal computers over a network such as the Internet (see, for example, Japanese Unexamined Patent Publication No. 2004-15482).

The nucleus of the interactive communication implemented by the television sets is to receive television broadcasts; i.e., the television sets are merely allowed to make supplementary transmissions to make responses in association with received program information. In other words, the television sets are not allowed to actively transmit image and audio information.

With the television communication system described in the aforementioned Patent Publication No. 2004-15482, it is possible to actively transmit image and audio information, but various environmental settings are required to be performed on personal computers. The use of personal computers makes the television communication system difficult to use for elderly persons, for example. At present, this television communication system is still greatly inferior, in terms of convenience, to television sets.

### BRIEF SUMMARY OF THE INVENTION

According to an embodiment of the present invention, a television set comprises a tuner which receives television broadcast program information; a communicating unit configured to communicate over a network; an image receiving unit configured to receive through the communicating unit image information transferred over the network; an operating unit; and a control unit configured to switch the subject of display from program information received by the tuner to image information received by the image receiving unit, when a predetermined operation is performed by the operating unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the operating environments of a digital television broadcast receiver according to a first embodiment of the present invention;

FIG. 2 is a schematic block diagram of the digital television broadcast receiver shown in FIG. 1;

FIG. 3 shows the exterior of the remote controller shown in FIG. 1;

FIG. 4 is a diagram for use in explanation of a form of use of the digital television broadcast receiver shown in FIG. 1;

FIG. 5 is a flowchart illustrating the operating procedure of the digital television broadcast receiver of FIG. 1 to send externally input moving image information over a network;

FIG. 6 is a flowchart illustrating the operating procedure of the digital television broadcast receiver of FIG. 1 to display moving image information received over the network;

FIG. 7 is a diagram for use in explanation of a form of use of a digital television broadcast receiver according to a second embodiment of the present invention;

FIG. 8 is a flowchart illustrating the operating procedure of the digital television broadcast receiver of the second embodiment in the sending of still image information recorded on a memory card over a network;

FIG. 9 is a flowchart illustrating the operating procedure of the digital television broadcast receiver of the second embodiment in the display of still image information received over the network;

FIGS. 10A and 10B are diagrams for use in explanation of a form of use of a digital television broadcast receiver according to a third embodiment of the present invention; and

FIG. 11 is a flowchart illustrating the operating procedure of the digital television broadcast receiver of the third embodiment.

### DETAILED DESCRIPTION OF THE INVENTION

The embodiments of the present invention will be described hereinafter with reference to the accompanying drawings.

### First Embodiment

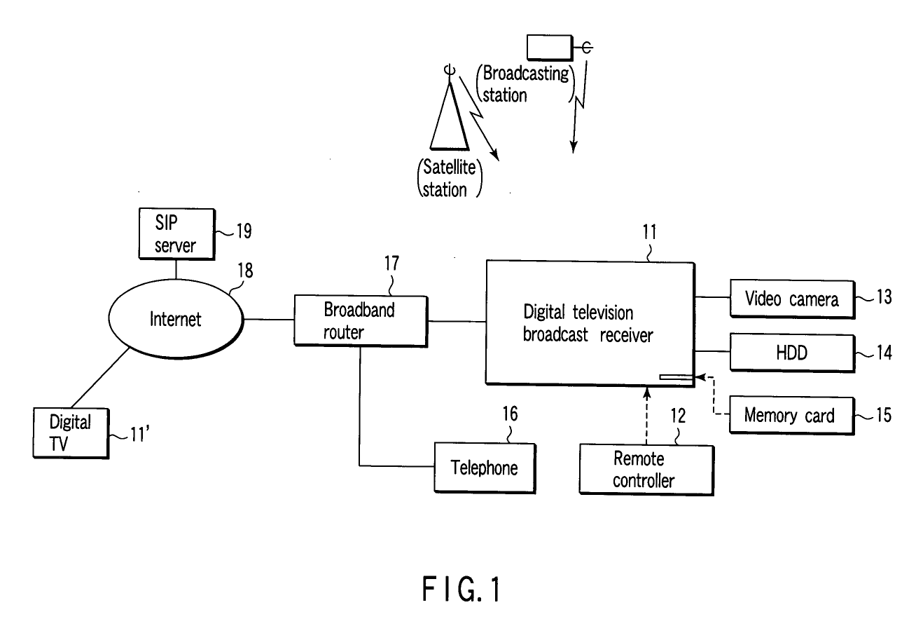

FIG. 1 shows the operating environment of a television set according to a first embodiment of the present invention. Here, the television set is described as a digital television broadcast receiver 11 capable of receiving terrestrial digital broadcasts and satellite digital broadcasts.

The digital television broadcast receiver 11 is configured so that it can be remotely controlled by a remote controller 12, connected to external devices, such as a video camera 13, a magnetic disk driver (HDD) 14, etc., and loaded with a memory card 15. That is, in response to operations on the remote controller 12, the digital television broadcast receiver 11 can receive and display program information on a desired terrestrial digital broadcasting channel or satellite digital broadcasting channel, display moving image information from the video camera 13, display recorded information on the HDD 14, or display still image information recorded on the memory card 15.

In addition, the digital television broadcast receiver 11 is connected to a broadband router 17 together with a telephone 16 to allow for communication with another digital television broadcast receiver (digital TV) 11′ over the Internet 18. It is assumed here that the digital television broadcast receiver 11 and the digital television broadcast receiver 11′ are of the same type. Control of originating and incoming calls for the digital television sets 11 and 11′ for initiating communication over the Internet 18 is exclusively performed by an SIP (Session Initiation Protocol) server 19.

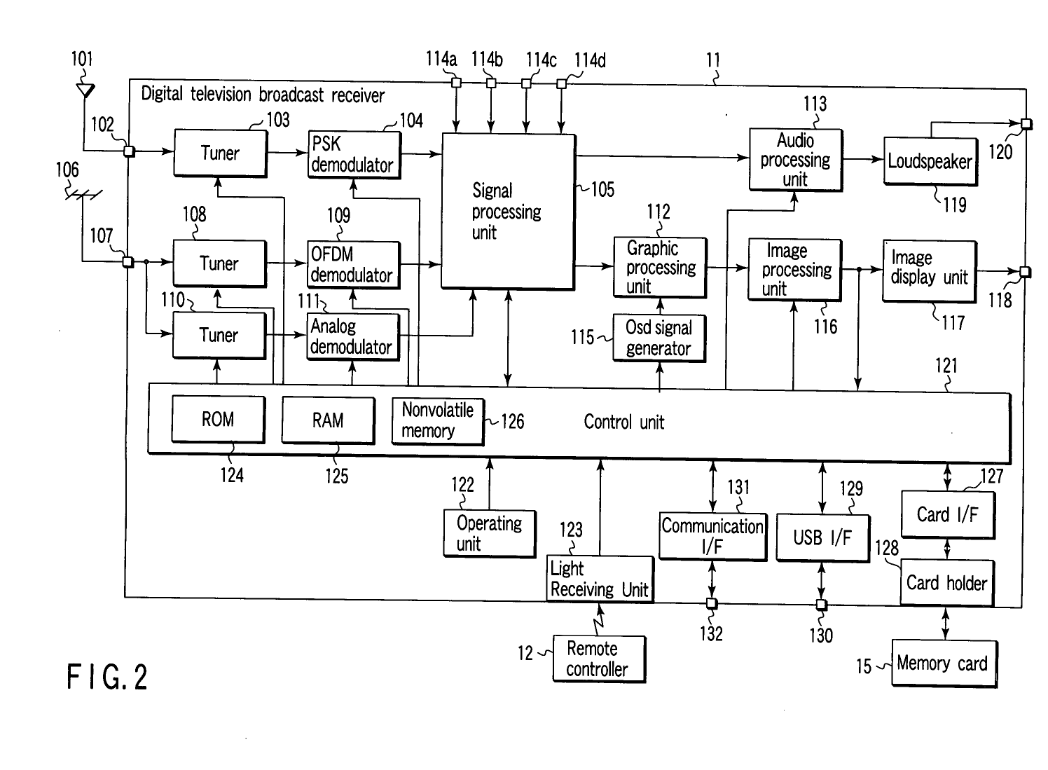

FIG. 2 is a schematic block diagram of the digital television broadcast receiver 11 of the first embodiment.

Satellite digital television broadcast signals received by a BS/CS digital broadcast receiving antenna 101 are applied through an input terminal 102 to a satellite digital broadcast tuner 103 where a broadcast signal on a desired channel is selected. The broadcast signal selected by the tuner 103 is then applied to a PSK (Phase Shift Keying) demodulator 104 to recover digital video and audio signals. The recovered signals are then output to a signal processing unit 105.

Terrestrial digital television broadcast signals received by a terrestrial broadcast receiving antenna 106 are applied through an input terminal 107 to a terrestrial digital broadcast tuner 108 where a broadcast signal on a desired channel is selected. The broadcast signal selected by the tuner 108 is then applied to an OFDM (Orthogonal Frequency Division Multiplexing) demodulator 109 to recover digital video and audio signals. The recovered signals are then output to the signal processing unit 105. Furthermore, terrestrial analog television broadcast signals received by the terrestrial broadcast receiving antenna 106 are applied through the input terminal 107 to a terrestrial analog broadcast tuner 110 where a broadcast signal on a desired channel is selected. The broadcast signal selected by the tuner 110 is then applied to an analog demodulator 111 to recover analog video and audio signals. The recovered signals are then output to the signal processing unit 105.

The signal processing unit 105 performs predetermined digital signal processing on digital video and audio signals from each of the PSK demodulator 104 and the OFDM demodulator 109 and then outputs the resulting digital video and audio signals to a graphic processing unit 112 and an audio processing unit 113, respectively. To the signal processing unit 105 are connected a plurality of input terminals 114a through 114d which allow external analog video and audio signals to be input to the digital television broadcast receiver 11. The video camera shown in FIG. 1 is connected to one of the input terminals 114a through 114d. The signal processing unit 105 digitizes analog video and audio signals from the analog demodulator 111 and the input terminals 114a through 114d, then performs predetermined digital signal processing on the digitized video and audio signals and outputs the resulting video and audio signals to the graphic processing unit 112 and the audio signal processing 113, respectively.

The graphic processing unit 112 has a function of superimposing an OSD (On Screen Display) signal generated by an OSD signal generator 115 on a digital video signal from the signal processing unit 105 and outputting the resulting signal. The graphic processing unit 112 selectively outputs an output video signal from the signal processing unit 105 or an output OSD signal from the OSD signal generator 115, to output both the output signals in superimposed form, or to output both the output signals in combined form so that each of them takes up half of the screen.

The digital image signal output from the graphic processing unit 112 is applied to a image processing unit 116 which converts the input digital image signal into an analog image signal of a format compatible with a image display unit 117, then outputs it to the display unit 117 and externally, via an output terminal 118.

The audio processing unit 113 converts the input digital audio signal into an analog audio signal of a format compatible with a loudspeaker 119, then outputs it to the loudspeaker 119 and externally, via an output terminal 120.

The digital television broadcast receiver 11 has its all operations controlled by a control unit 121 which has a CPU (Central Processing Unit) built in. The control unit 121 receives operation information from an operating unit 122 or operation information transmitted from a remote controller 12 through a light receiving unit 123 and controls each component so that the contents of operations are reflected. The control unit 121 mainly uses a ROM (Read Only Memory) 124 to store control programs executed by the CPU, a RAM (Random Access Memory) 125 to provide the CPU with a working area, and a nonvolatile memory 126 to store various setting and control information.

The control unit 121 is connected through a card I/F (Interface) 127 to a card holder 128 into which the memory card 15 shown in FIG. 1 is loaded. The control unit 121 is thus enabled to transmit information to or receive information from the memory card 15 via the card I/F 127. Further, the control unit 121 is connected through a USB I/F 129 to a USB terminal 130. The control unit 121 can thus transmit information to or receive information from equipment connected to the USB terminal 130 via the USB I/F 129. The HDD 14 shown in FIG. 1 is connected to the USB terminal 130.

The control unit 121 is connected through a communication I/F 131 to a LAN terminal 132 which is connected through the broadband router 17 shown in FIG. 1 to the Internet 18. The control unit 121 can thus to make information communication with the digital television broadcast receiver 11′ under the control of the SIP server 19.

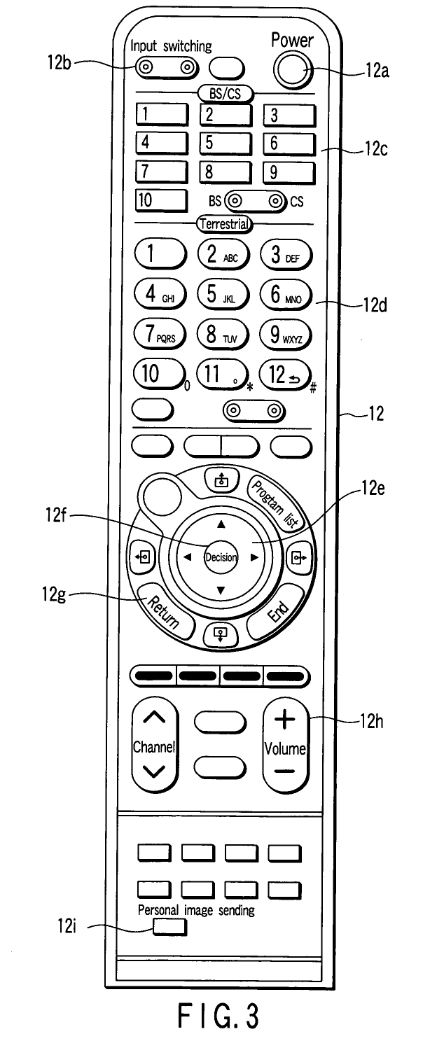

FIG. 3 is an exterior view of the remote controller 12. The remote controller is equipped mainly with a power key 12a, an input switching key 12b, direct channel selector keys 12c for satellite digital broadcast channels, direct channel selector keys 12d for terrestrial broadcast channels, a cursor key 12e, a decision key 12f, a return key 12g, a volume adjust key 12h, and a personal image sending key 12i.

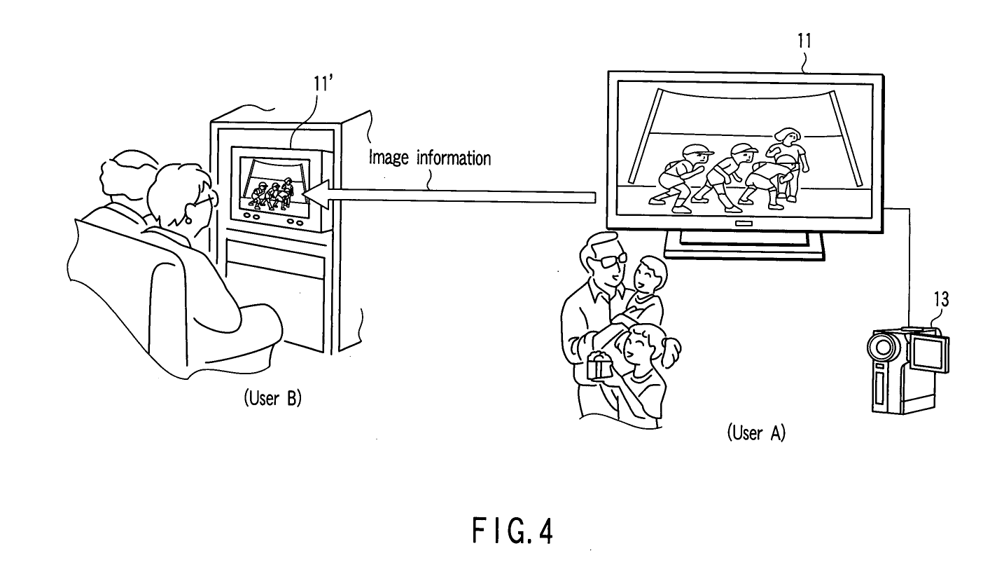

Reference is now made to FIG. 4 to describe a form of use of the digital television broadcast receiver 11 of the first embodiment.

The user A of the digital television broadcast receiver 11 is now thinking of wanting the user B of the digital television broadcast user 11′ who resides in a remote location to watch moving images captured by the video camera 13. In this case, the user A telephones the user B to that effect and then performs the following operations on the digital television broadcast receiver 11. Suppose that the digital television broadcast receiver 11 has been switched on.

The user A first connects the video camera 13 recorded with the moving images to one of the input terminals 14a through 14d. The user A then operates the input switching key 12b of the remote controller 12 so that the moving images are displayed on the image display unit 117. When notified of the operation of the input switching key 12b, the control unit 121 informs the signal processing unit 105 of which input to receive.

Next, the user A operates the personal image sending key 12i on the remote controller 12 in order to send the moving image signals from the video camera 13 which are being displayed on the image display unit 117 to the digital television broadcast receiver 11′ of the user B. When notified of the operation of the personal image sending key 12i, the control unit 121 instructs the OSD signal generator 115 to operate the graphic processing unit 112 so as to cause the image display unit 117 to display a screen for allowing the user to enter the address of a location to which the moving images being displayed are to be sent. Upon entry of the destination address, the control unit 121 requests the SIP server 19 through the communication I/F 131 to set up connection to the destination the address of which has been entered on that screen. When the connection has been set up, the control unit 121 sends moving image information being displayed, i.e., being output from the signal processing unit 105, to the destination television set through the communication I/F 131.

Upon receiving a telephonic communication from the user A, on the other hand, the user B depresses one of the direct channel select keys 12d of the remote controller 12 which corresponds to a dedicated channel previously assigned for the display of moving images received over the Internet 18 on the display unit 117, more specifically, an idle channel in the area where the user B resides. When notified of the depression of the dedicated channel key, the control unit 121 causes the communication I/F 130 to receive the moving image information addressed to the television set 11′ and transfer it to the signal processing unit 105. The control unit 121 instructs the signal processing unit 105 to select the moving image information as the subject of display. Thus, the user B may watch images sent from remote locations by merely performing a simple operation of selecting a desired channel from among multiple channels.

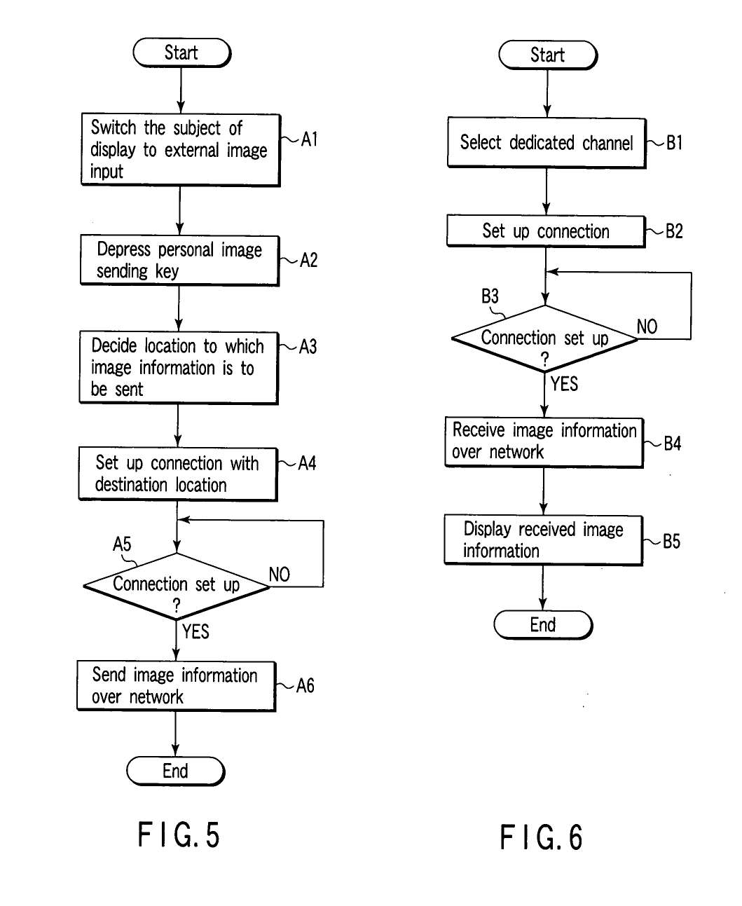

Reference is next made to FIGS. 5 and 6 to describe the operating procedures of the digital television broadcast receiver 11 of the first embodiment. FIG. 5 is a flowchart illustrating the operating procedure of sending externally input moving image information over a network. FIG. 6 is a flowchart illustrating the operating procedure of displaying moving image information received over the network.

In transmitting externally input moving image information over a network, the control unit 121 first responds to an operation of the input switching key 12b to switch the input to be processed by the signal processing unit 105 as the subject of display to a desired external input (step A1). When the personal image sending key 12i of the remote controller 12 is depressed (step A2), the control unit 121 determines a destination and sets up connection with it (steps A3 and A4). When the connection has been set up (YES in step A5), the control unit 121 sends moving image information being displayed to the destination via the communication I/F 130 (step A6).

In displaying moving images received over a network, the dedicated channel is first selected by depressing one of the direct channel select keys 12d of the remote controller 12 (step B1). The control unit 121 then sets up connection with the location from which the moving images are sent (step B2). When the connection has been set up (YES in step B3), the control unit 121 receives the moving images via the communication I/F 130 (step B4) and then displays them on the display unit 117 (step B5).

Thus, the digital television broadcast receiver 11 of the first embodiment can be operated with ease to implement interactive communication that allows active reception and transmission of image information.

### Second Embodiment

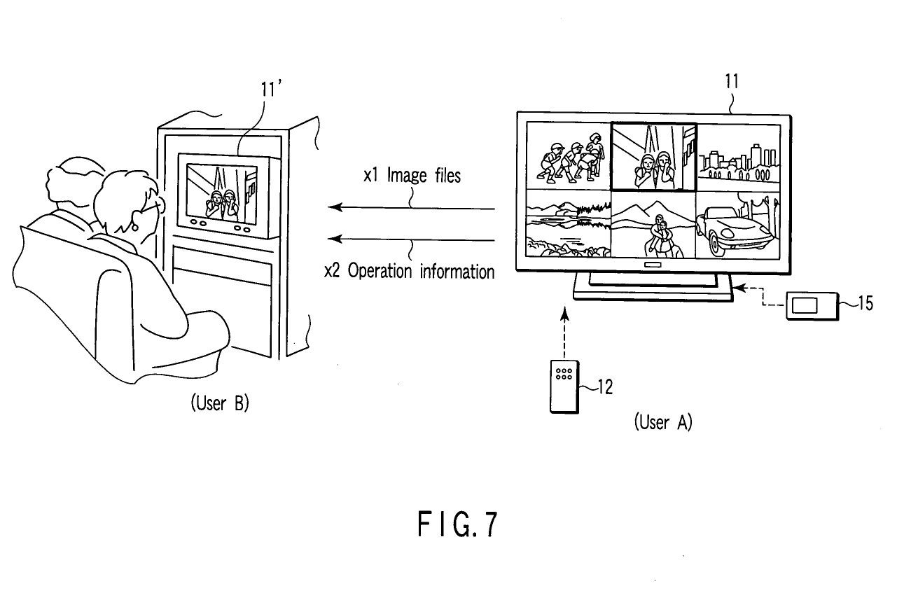

A second embodiment of the present invention will be described next. A digital television broadcast receiver 11 according to the second embodiment is an application of the digital television broadcast receiver 11 of the first embodiment which has a function of actively receiving and transmitting image information over a network. The operating environments, configuration, and external appearance of the remote controller remain unchanged from those of the first embodiment; therefore, descriptions thereof are omitted here. FIG. 7 illustrates a form of use of the digital television broadcast receiver 11 of the second embodiment.

The user A of the digital television broadcast receiver 11 is now thinking of wanting the user B of the digital television broadcast user 11′ who resides in a remote location to watch still images recorded on the memory card 15. Still images recorded on the memory card 15 include images captured by a digital still camera. In this case, the user A telephones the user B to that effect and then performs the following operations on the digital television broadcast receiver 11. Suppose that the digital television broadcast receiver 11 has been switched on.

The user A first loads the memory card 15 recorded with still image information into the card holder 127 and then performs input switching by operating the input switching key 12b of the remote controller 12 so that still image information recorded on the memory card 15 is displayed on the image display unit 117. When the memory card 15 is selected by operating the input switching key 12b, the control unit 121 makes access to the memory card 15 and transfers the read still image information to the signal processing unit 105.

Next, the user A operates the personal image sending key 12i on the remote controller 12 in order to send the still image information from the memory card 15 which is being displayed on the image display unit 117 to the digital television broadcast receiver 11′ of the user B. When notified of the operation of the personal video sending key 12i, the control unit 121 instructs the OSD signal generator 115 to operate the graphic processing unit 112 so as to cause the image display unit 117 to display a screen for allowing the user to enter the address of a location to which the still image information being displayed is to be sent. Upon entry of the destination address, the control unit 121 requests the SIP server 19 through the communication I/F 131 to set up connection with the destination entered on that screen. When the connection has been set up, the control unit 121 sends still image files recorded on the memory card 15 to the destination television set through the communication I/F 131 (X1 in FIG. 7).

The operations associated with the display of still images recorded on the memory card 15 are performed by the cursor key 12e, the decision key 12f, the return key 12g and so on of the remote controller 12. These operations allow desired still images to be selected as the subject of display. When notified of these operations, the control unit 121 sends operation information indicating the contents of the operations to the destination through the communication I/F 130 (X2 in FIG. 7).

Upon receiving a telephonic communication from the user A, on the other hand, the user B depresses one of the direct channel select keys 12d of the remote controller 12 which corresponds to a dedicated channel previously assigned for the display of still image information received over the Internet 18 on the display unit 117, for example, the key for channel 11. When notified of the depression of the dedicated channel key, the control unit 121 causes the communication I/F 130 to receive still image files addressed to the television set 11′.

The control unit 121 causes the communication I/F 130 to receive operation information sent from the television set 11, then transfers still images selected from among previously received still images to the signal processing unit 105 on the basis of the received operation information and displays them on the display unit 117. Thereby, the operations by the user A are reflected in the television set 11′ of the user B in a remote location. Thus, the user A may enable the user B to watch desired images while having communication with him or her by telephone.

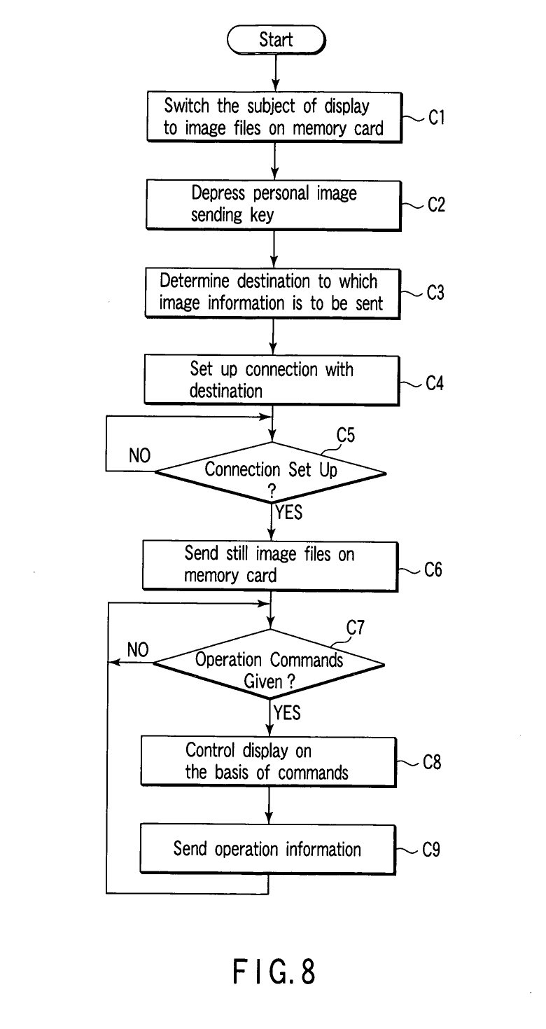

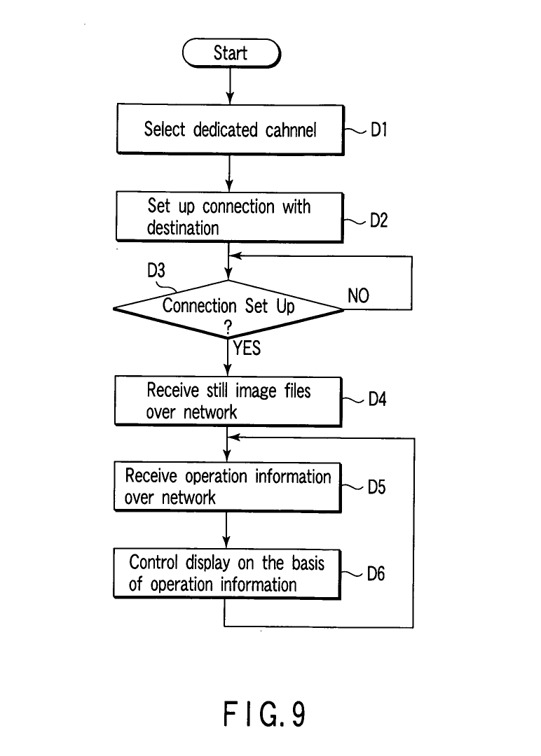

Reference is next made to FIGS. 8 and 9 to describe the operating procedures of the digital television broadcast receiver 11 of the second embodiment. FIG. 8 is a flowchart illustrating the operating procedure of transmitting still image information recorded on the memory card 15 to a receiving location over a network. FIG. 9 is a flowchart illustrating the operating procedure of displaying still image information received from a sending location over the network.

In transmitting still image information recorded on the memory card 15 over a network, the control unit 121 first responds to an operation of the input switching key 12b to switch the input to be processed by the signal processing unit 105 as the subject of display to the still image information on the memory card (step C1). When the personal image sending key 12i of the remote controller 12 is depressed (step C2), the control unit 121 determines a destination and sets up connection with it (steps C3 and C4). When the connection has been set up (YES in step C5), the control unit 121 sends still image files on the memory card to the destination via the communication I/F 130 (step C6).

Next, when operation commands associated with still image display are given by the remote controller 12 (step C7), the control unit 121 instructs the signal processing unit 105, the OSD signal control unit 115, and the image processing unit 116 to control the display of the image display unit 117 (step C8) on the basis of the operation commands and sends information indicating the operation commands to the destination via the communication I/F 130 (step C9).

In displaying still image information received over a network, a dedicated channel is first selected by depressing one of the direct channel select keys 12d of the remote controller 12 (step D1). The control unit 121 then sets up connection with the location from which the still image information is sent (step D2). When the connection has been set up (YES in step D3), the control unit 121 receives the still image information via the communication I/F 130 (step D4) and receives the operation information arbitrarily (step D5). Based on the received operation information, the control unit 121 instructs the signal processing unit 105, the OSD signal control unit 115, and the image processing unit 116 to display the received still image files on the display unit 117 (step D6).

Thus, the digital television broadcast receiver 11 of the second embodiment can be operated with ease to implement interactive communication that allows active reception and transmission of image information.

### Third Embodiment

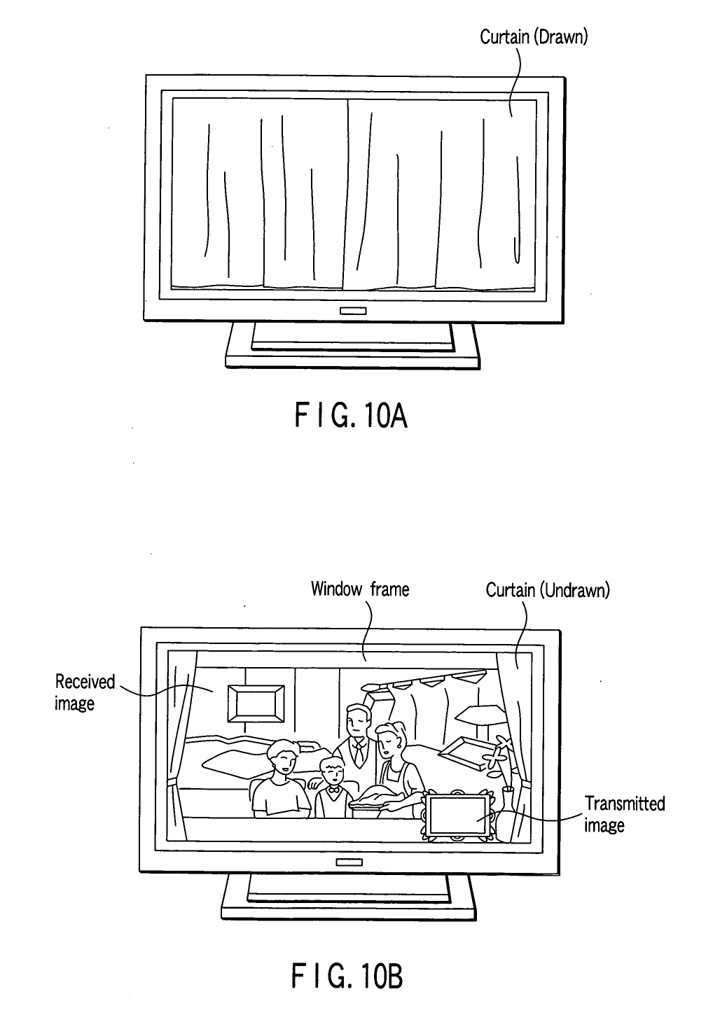

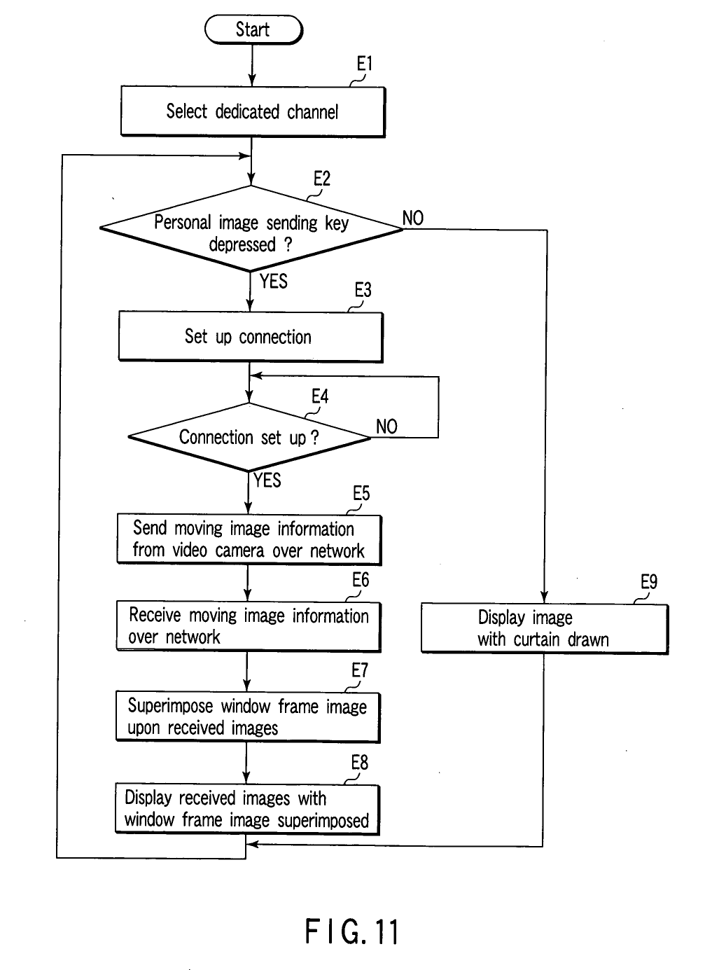

A third embodiment of the present invention will be described next. A digital television broadcast receiver according to the third embodiment is also an application of the digital television broadcast receiver 11 of the first embodiment which has a function of actively receiving and transmitting image information over a network. The operating environments, configuration, and external appearance of the remote controller remain unchanged from those of the first embodiment; therefore, descriptions thereof are omitted here. FIGS. 10A and 10B illustrate a form of use of the digital television broadcast receiver 11 of the third embodiment.

In the third embodiment, two remotely located digital television broadcast receivers 11 connected through the Internet 18 communicate moving images captured by video cameras 13 to each other. The third embodiment provides a function to be called a television-based string telephone. The dedicated channel described in the description of the first and second embodiments is assigned as a channel to display moving images communicated between the television sets. If, when the dedicated channel is selected, no moving images are communicated between the television sets, an image which looks as if a curtain were drawn is displayed as shown in FIG. 10A. The communication of moving images is initiated by depressing the personal image sending key 12i of the remote controller 12. As shown in FIG. 10B, the received moving images are displayed with an image of a window frame superimposed on their periphery. That is, the received moving images look as if a room were viewed through a window with the curtain undrawn. The transmitted moving images captured by the video camera 13 on the transmission side are also displayed in a portion of the same display screen. When the personal image sending key 12i of the remote controller 12 is depressed again, the communication of moving images is complete and a return is made to the image of FIG. 10.

That is, merely performing a common operation of selecting a desired channel from among multiple channels allows communication of moving images with a remote location. Moreover, the presence or absence of communication of moving images can be informed by a visually-easy-to-understand display such as of the curtain being drawn or undrawn.

Reference is next made to FIG. 11 to describe the operating procedures of the digital television broadcast receiver 11 of the third embodiment.

When the dedicated channel is selected by depressing the specific key of the direct channel select keys 12d of the remote controller 12 (step E1), the control unit 121 changes the subject of display to moving images received through the communication I/F 130 and examines whether or not the personal image sending key 12i of the remote controller 12 has been depressed (step E2). If the personal image sending key 12I has been depressed (YES in step E2), then the control unit 121 sets up the connection with the location to which moving image information is to be communicated (step E3). When the connection has been set up (YES in step E4), the control unit 121 sends moving image information from the video camera 13 through the communication I/F 130 (step E5) and receives moving image information through the communication I/F 130 from the location with which the connection has been set up (step E6). The control unit 121 then superimposes an image of a window frame upon the received moving image information (step E7) and displays on the display unit 117 the moving image information with the widow frame image superimposed (step E8).

If, on the other hand, the personal image sending key 12i is not depressed though the dedicated channel has been selected (NO in step E2), then the control unit 121 displays an image with the curtain drawn on the display unit 117 (step E9).

Thus, the digital television broadcast receiver 11 of the third embodiment can be operated with ease to implement interactive communication that allows active reception and transmission of image information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A television set comprising:
a tuner which receives television broadcast program information;
a communicating unit configured to communicate over a network;
an image receiving unit configured to receive through the communicating unit image information transferred over the network;
an operating unit; and
a control unit configured to switch the subject of display from program information received by the tuner to image information received by the image receiving unit, when a predetermined operation is performed by the operating unit.

2. The television set according to claim 1, wherein the predetermined operation is an operation to select a dedicated channel previously assigned for the display of image information received by the image receiving unit from among multiple channels.

3. The television set according to claim 1, further comprising:
an input terminal to which image information is applied; and
an image transmitting unit configured to transmit the image information applied to the input terminal over the network.

4. The television set according to claim 1, further comprising:
a storage unit; and
an image transmitting unit configured to transmit image information stored in the storage unit over the network through the communication unit.

5. A television set comprising:
a communicating unit configured to communicate over a network;
an image receiving unit configured to receive through the communicating unit pieces of still image information transferred over the network;
a control signal receiving unit configured to receive control signals transferred over the network for controlling the display of the pieces of still image information received by the image receiving unit; and
a display control unit configured to control the display of the pieces of still image information received by the image receiving unit based on the control signals received by the control signal receiving unit.

6. The television set according to claim 5, further comprising a holder into which a storage medium is removably loaded;
an image transmitting unit configured to transmit pieces of still image information stored on the storage medium loaded into the holder over the network through the communicating unit;
an operating unit configured to perform operations associated with display control of the pieces of still image information stored on the storage medium; and
a control signal transmitting unit configured to transmit control signals indicating a contents of an operation over the network through the communication unit, when the operation is performed on the operating unit.

7. The television set according to claim 5, further comprising:
a storage unit;
an image transmitting unit configured to transmit pieces of still image information stored in the storage unit over the network through the communication unit;
an operating unit configured to perform operations associated with display control of the pieces of still image information stored in the storage unit, and a control signal transmitting unit configured to transmitting control signals indicating a contents of a operation over the network through the communication unit, when the operation is performed on the operating unit.

8. A television set comprising:
a communicating unit configured to communicate over a network;
an image receiving unit configured to receive through the communicating unit image information transferred over the network; and
a control unit configured to control display of received image information, when the image information is received by the image receiving unit, and to control display of an image representing a state in which a curtain is drawn, when no image information is received by the image receiving unit.

9. The television set according to claim 8, further comprising an image processing unit configured to perform image processing on the image information, and
the control unit causes the image processing unit to perform image processing so that an image of a window frame is superimposed on the periphery of a received image, in display control of the image received by the image receiving unit.

10. The television set according to claim 8, further comprising:
an input terminal to which image information is applied, and
an image transmitting unit configured to transmit the image information applied to the input terminal over the network.

11. The television set according to claim 8, further comprising:
a camera which captures an image, and
an image transmitting unit configured to transmit the image captured by the camera over the network through the communication unit.
